(19) United States
(12) Patent Application Publication
(10) Pub. No.: US 2011/0250123 A1
(43) Pub. Date: Oct. 13, 2011

(54) Methods and apparatus for producing the halogen dioxide, chlorine dioxide, by ion exchange

(76) Inventors: Richard L. Sampson, Fair Oaks Ranch, TX (US); Allison H. Sampson, Fair Oaks Ranch, TX (US)

(21) Appl. No.: 13/165,611

(22) Filed: Jun. 21, 2011

Related U.S. Application Data
(63) Continuation of application No. 11/790,771, filed on Apr. 27, 2007, now abandoned.
(60) Provisional application No. 60/795,598, filed on Apr. 28, 2006.

(51) Int. Cl. C01B 11/02; G01N 1/00

(52) U.S. Cl. 423/477; 422/119

(57) ABSTRACT

The halogen dioxide, chlorine dioxide is produced from its chlorite reactant using ion exchange media in a stable reactant form, and then passing a known concentration of counter ions through the ion exchange media in a moist environment so that there is an exchange of ions, and the reactants that are released form activated chlorine dioxide within the ion exchange material. The ion exchange media both contributes reactants to and extracts contaminants from the moist environment via its ion exchange mechanism. The counter ions may be derived from one or more stable precursor solutions which themselves may contain reactants and/or soluble catalysts. The reactants of the precursor solutions cannot act as the counter ion, or ions, in the ion exchange mechanism, but the soluble catalysts can. The ion exchange media can be mixed or layered with one or more insoluble catalysts, to enhance the formation of the activated halogen dioxide, chlorine dioxide within the ion exchange material.

This application claims priority to Provisional U.S. Patent Application Ser. No. 60/795,598, filed Apr. 28, 2006, and to U.S. patent application Ser. No. 11/790,771, filed Apr. 27, 2007, each of which is incorporated by reference as if set forth herein in its entirety.

### BACKGROUND OF THE INVENTION

1. Field of Invention

The present invention relates generally to methods and apparatus for producing the halogen dioxide, chlorine dioxide, from its chlorite reactant using ion exchange media in a stable reactant form. More specifically, the present invention relates to methods and apparatus for producing chlorine dioxide using such an ion exchange media in a moist environment in which the ion exchange media both contributes reactants to and extracts contaminants from the moist environment via its ion exchange mechanism.

2. Description of Prior Art

The generation of chlorous acid by the acidification of an aqueous chlorite salt solution or stabilized aqueous chlorine dioxide solution (stabilized chlorite salt solution) by an acid is well known by the following reaction:

Na⁺ClO₂⁻+H⁺->H⁺ClO₂⁻+Na⁺ (1).

It is also well known that over time, chlorous acid slowly decomposes to chlorine dioxide by the following decomposition reaction:

4HClO₂->2ClO₂+HClO₃+HCl+H₂O (2).

Reaction (2) predominates unless a catalyst exists. Such catalysts include excess chloride ion as a soluble catalyst or an insoluble catalyst as described in our U.S. Pat. No. 7,087,208, the disclosure of which is expressly incorporated herein by reference as if set forth in its entirety. In the cases where a catalyst is present, the following disproportionation reaction predominates:

5HClO₂->4ClO₂+HCl+H₂O (3).

It is also well known that in an oxidizing environment, such as in the presence of ozone, chlorine or an anode, chlorine dioxide can be generated from chlorous acid by the following reaction:

HClO₂−e⁻->ClO₂+H⁺ (4).

The use of chlorine dioxide in many applications has been limited due to the inability to control the reaction chemistries and the inefficiency of the related reactions in solutions. Since chlorine dioxide is an unstable gas, even in solution, it must be generated on-site and used shortly after generation. Large volume industrial applications such as pulp and paper bleaching, municipal water pretreatment and disinfection including membrane disinfection, food processing disinfection, and cooling tower disinfection have been successful due to the ability in these applications to safely handle concentrated and aggressive oxidizers and acids.

Some consumer and medical applications have also had success. Chlorite salt-based toothpastes, mouthwashes, and disinfecting skin gels use either the pH of the mouth or a weak-acid activator to slightly acidify the chlorite salt so that some chlorous acid is formed. The chlorous acid will then slowly decompose to the halogen dioxide, chlorine dioxide by reaction (2) above.

There are some applications, however, that have shown great promise for chlorine dioxide but have not been successful to date due to existing generation methods. One notable example is the disinfection of membrane systems, such as reverse osmosis membrane systems. W. R. Adams in “The Effects of Chlorine Dioxide on Reverse Osmosis Membranes” (1990) (hereinafter “Adams”) goes into great detail describing the success he had in disinfecting reverse osmosis membranes and how chlorine dioxide disinfects both upstream and downstream of the membranes preventing biofouling of the membranes. This lack of biofilm is demonstrated through the lack of loss of flux throughout the study, and since biofouling can destroy the performance of membrane systems, chlorine dioxide holds such great promise.

However, there is a need for an ion exchange technology for producing the halogen dioxide, chlorine dioxide from its chlorite reactant using an ion exchange media in a stable reactant form in a moist environment in which the ion exchange media both contributes reactants to and extracts contaminants from the moist environment via its ion exchange mechanism.

### SUMMARY OF THE INVENTION

In accordance with the present invention, it has now been found that the halogen oxide, chlorine dioxide can be produced from its chlorite reactant using ion exchange media in a stable reactant form, and then passing a known concentration of counter ions through the ion exchange media in a moist environment so that there is an exchange of ions. The precursor solution or solutions containing the known concentration of counter ions may themselves contain reactants, but the reactants themselves cannot act as the counter ion or ions in the ion exchange mechanism (i.e. the ions that exchange onto the ion exchange media and drive off the ions that already occupy the ionic sites). The precursor solution or solutions may contain both the counter ions and the reactants. The reactants that are released by the ion exchange together with any reactants found in the precursor solution or solutions (the solutions which feed into the ion exchange media) form the activated halogen dioxide, chlorine dioxide in the moist environment within the ion exchange material.

It has also been surprisingly found that the ion exchange media can both contribute reactants to the moist environment and extract contaminants from the moist environment via its ion exchange mechanism.

The source of the counter ions which can be present in the moist environment is preferably derived from one or more stable precursor solutions, which themselves may contain reactants and/or soluble catalysts. However, any reactant or reactants found in the stable precursor solutions cannot act as the counter ion in the ion exchange mechanism, but the soluble catalyst can act as the counter ion in the ion exchange mechanism. In addition, it is contemplated that the ion exchange media of the present invention can be present in a singular, mixed or layered form in a container, with or without the addition of one or more insoluble catalysts.

Ion exchange materials, such as inorganic and organic resins, membranes, powders, gels, and solutions are well known to those skilled in the art, and the type of ion exchange material selected for use in carrying out the present intention is not intended to limit the scope of the invention. Examples of the many ion exchange materials which can be used in carrying out the present invention include, but are not limited to, weak acid cation resins and powders, strong acid cation resins and powders, weak base anion resins and powders, strong base anion resins and powders, sulfonated polystyrene solutions, zeolites, cation and anion selective membranes. Selection of a particular ion exchange material is considered within the skill of those knowledgeable in the art.

In addition, the ion exchange materials used in accordance with the present invention can be singular, mixed or layered with other ion exchange materials and/or inert substrates. The choice of a particular configuration for the ion exchange materials and/or the combination of ion exchange materials and/or inert materials is considered within the skill of those knowledgeable in the art. An example of how the ion exchange media can perform similar functions in different configurations is exemplified in common water purification by ion exchange. In some applications, it is desirable to have a cation exchange resin in one container followed by an anion exchange resin in a second container. In other applications, it is desirable to have such resins layered one on top of the other within the same container. In yet another application, it is desirable to have such resins mixed together within the same container. In still another example, the mixed resins are further mixed with an inert material to aid in regeneration within the same container. Furthermore, the shape or configuration of the container can be, for example, in a column or tube or cartridge, and is not limited in any way. All of these configurations and more are well known to those skilled in the art of ion exchange.

The catalysts of the present invention can be of the soluble type, such as chloride ion in solution, as described in U.S. Pat. No. 5,092,970 to Kaczur, and U.S. Pat. No. 5,008,096 to Ringo. In addition, the catalysts can also be of the insoluble type, such as described in our aforesaid U.S. Pat. No. 7,087,208, or a combination of both types of catalysts. Selection of a particular catalyst is considered within the skill of those knowledgeable in the art.

The preferred moist environment for producing the activated halogen dioxide, chlorine dioxide in accordance with the present invention is an aqueous solution or an aqueous aerosol or vapor.

In one embodiment according to the present invention, the source of the counter ions can be from one or more stable precursor solutions in which the precursor solutions may contain reactants and/or soluble catalysts themselves. For example, the precursor solutions may contain the chlorite reactant.

In an alternate embodiment according to the present invention, the ion exchange media can be mixed or layered with one or more insoluble catalysts to enhance the formation of the activated halogen dioxide, chlorine dioxide within the ion exchange material.

It is therefore an object of the present invention to produce an active species of halogen dioxide, namely chlorine dioxide, from its chlorite reactant by using ion exchange media in a stable and inactive reactant form, followed by passing a known concentration of counter ions, from one or more stable precursor solutions, in a moist environment, over said ion exchange media, so as to cause the controlled exchange of counter ions with the reactant ions such that the activated chlorine dioxide species is released within the ion exchange media into the moist environment.

It is also an object of the present invention that the ion exchange media of the present invention, in its stable and inactive reactant form, can be provided in separate form, layered form or a mixed form, such that the active halogen dioxide, chlorine dioxide is produced in multiple steps or in a single step.

It is a further object of the present invention that the ion exchange media used in the present invention can be provided in a stable and inactive reactant form by using regeneration technologies and techniques that are well known in the art, and that the ion exchange media used in the present invention may be regenerated and reused repeatedly, if so desired. In the alternative, the ion exchange media can be disposable.

It is still a further object of the present invention that the ion exchange media used in the present invention be capable of contributing reactants to and extracting contaminants from a moist environment.

It is yet another object of the present invention that the reactants of the ion exchange media of the present invention can be derived from either a single precursor solution or multiple precursor solutions in conjunction with the ion exchange media.

It is still another object of the present invention that the single or multiple precursor solutions of the present invention may contain one or more soluble catalysts.

Yet a further object of the present invention is that the ion exchange media provided can be mixed and/or layered with one or more insoluble catalysts to enhance the formation of the activated halogen dioxide, chlorine dioxide within the ion exchange material.

These and other objects of the invention, as well as many of the attendant advantages thereof, will become more readily apparent when reference is made to the following detailed description of the preferred embodiments.

### BRIEF DESCRIPTION OF THE DRAWINGS

FIG. 1 is a depiction of the typical container for the ion exchange material in the shape of a column or test tube used in conjunction with the processes described.

FIG. 2 is a schematic diagram showing a possible apparatus for carrying out a process in accordance with the present invention wherein each ion exchange material is separate from other ion exchange materials. In the FIG. 2 embodiment, the ion exchange material can be mixed with either an insoluble catalyst or an additive.

FIG. 3 is a schematic diagram showing an alternate apparatus for carrying out a process in accordance with the present invention wherein one ion exchange material is mixed or layered with other ion exchange materials. In the embodiment depicted in FIG. 3, the ion exchange material can also be mixed with either an insoluble catalyst or an additive.

FIG. 4 is a schematic diagram showing an alternate apparatus for carrying out a process in accordance with the present invention wherein more than one stable precursor solutions is used as the source of the counter ions. These stable precursor solutions may contain one or more reactants and/or soluble catalysts. The ion exchange media may be separate, mixed, or layered, and may be further mixed or layered with one or more insoluble catalyst.

### DETAILED DESCRIPTION AND PREFERRED EMBODIMENTS

In describing the embodiments of the invention, specific terminology will be resorted to for the sake of clarity. However, the invention is not intended to be limited to the specific terms so selected, and it is to be understood that each specific term includes all technical equivalents which operate in a similar manner to accomplish a similar purpose.

As used herein, the term “solution” shall mean a mixture formed by a process by which a solid, liquid, or gaseous substance is mixed with a liquid, whether that liquid is a droplet, aerosol, vapor, or mist. Also, as used herein, the term “moist environment” shall mean that the environment in which the reaction occurs contains moisture, ranging from a slightly humid environment to a fully wet environment, such as an aqueous solution. Also, as used herein, the term “precursor” shall be used to mean any solution and/or combination of solutions used to generate the halogen dioxide, chlorine dioxide. Also, as used herein, the term “disposable” shall be used to mean that the ion exchange media is used once and discarded.

For purposes of the present invention, counter ions can be an ion of any element. However, in the present invention it is preferable to choose from among strong counter ions. Examples of strong counter ions for the present invention include hydrogen, calcium, magnesium, manganese, iron, potassium and lithium for cations and hypochlorite, chlorite, chlorate, chloride, sulfate, phosphate, and nitrate for anions.

Ion exchange materials which may be used in the present invention, such as inorganic and organic resins, membranes, powders, gels, and solutions, are well known to those skilled in the art, and the type or types of ion exchange materials used is not intended to limit the invention. Examples of ion exchange materials which can be used in carrying out the present invention include, but are not limited to, weak acid cation resins and powders, strong acid cation resins and powders, weak base anion resins and powders, strong base anion resins and powders, sulfonated polystyrene solutions, zeolites, cation and anion selective membranes. Selection of a particular ion exchange material is considered within the skill of those knowledgeable in the field. Further, the choice of a particular configuration, whether in a singular, layered or mixed form, for the ion exchange materials and/or the combination of ion exchange materials and/or inert materials is considered within the skill of those knowledgeable in the field.

It is also within the skill of one knowledgeable in the art to add one or more additives to the ion exchange material. Such additives may include, but are not limited to, inert insoluble materials, such as the base material for ion exchange resin before it is converted into its cationic or anionic form, which may also be provided in a mixed or layered form within the ion exchange material. The additives can also be soluble materials which, when dissolved, may or may not contribute counter ions to the process.

By definition, catalysts work by changing the activation energy for a reaction, i.e. the minimum energy needed for the reaction to occur. This is accomplished by providing a new mechanism or reaction path through which the reaction can proceed. When the new reaction path has a lower activation energy, the reaction rate is increased, and the reaction is said to be catalyzed.

There are many catalysts that can be used within the scope of the present invention. These include, but are not limited to platinum, palladium, manganese dioxide, carbon, silver, and ion exchange material. Further, it is well known that depositing catalysts on various substrates, such as zeolites or porous non-ionic substrates, aids in the catalysis by increasing surface area. Such catalysts and catalyst substrates are commercially available, and it is within the scope of those skilled in the art to choose an appropriate catalytic material and/or substrate to catalyze the reaction of an inactive precursor to the active halogen oxide, chlorine dioxide.

In one preferred embodiment of the present invention, a cation exchange resin in the hydrogen form is layered with a mixture of: 1) an anion exchange resin in the chlorite form and 2) an insoluble catalyst, such that the singular cation resin forms the first layer, and the mixture of anion resin and insoluble catalyst forms the second layer. A solution containing sodium sulfate (Na₂SO₄) is then passed over the ion exchange resins such that the sodium ion of the sodium sulfate is exchanged with the hydrogen ion on the cation exchange resin, and the sulfate ion of the sodium sulfate is exchanged with the chlorite ion on the anion exchange resin, in the presence of an insoluble catalyst, to form the active halogen dioxide, chlorine dioxide, within the ion exchange resin bed. The equation describing this reaction follows:

5Na₂SO₄+10RH+10RClO₂+catalyst-->8ClO₂+10RNa+5R₂SO₄+4H₂O+2HCl (5).

A further property of this embodiment is that any cationic contaminant, either from the precursor solution or formed as a byproduct of the reaction, is removed with the cation exchange resin, and in the same manner, any anionic contaminant, either from the precursor solution, or formed as a byproduct of the reaction, is removed with the anion exchange resin of the present invention.

In a further embodiment of the present invention, a cation exchange resin in the hydrogen form is layered with anion exchange resin in the chlorite form. A NaCl solution containing sodium ion and chloride ion, where the chloride ion is acting as the soluble catalyst, is passed over the ion exchange resins such that the sodium ion from the NaCl solution is exchanged with the hydrogen ion on the cation exchange resin, and the soluble catalyst chloride ion from the NaCl solution, is exchanged with the chlorite ion on the anion exchange resin to form the active halogen dioxide, chlorine dioxide, within the ion exchange resin bed. The equation describing this reaction follows:

5NaCl+5RH+5RClO₂+catalyst--->4ClO₂+5RNa+5RCl+2H₂O+HCl (6).

In a still further embodiment, activated halogen dioxide, chlorine dioxide, is made by providing a cation exchange resin in the H⁺ form and also providing an anion exchange resin with a mixture of anions attached thereto. The mixture of anions attached to the anion exchange resin can be achieved, for example, by starting with an anion exchange resin already in the hydroxyl (OH⁻) form and dividing the resin into two parts. One part is treated to exchange the chlorite ion for some of the hydroxyl ion, and the second part is treated to exchange the hypochlorite ion for some of the hydroxyl ion. The hydroxyl ion part of the anion exchange resin is retained to help ensure stability of the chlorite and hypochlorite ions through its (OH⁻) effect on the pH of the resin. Other methods for achieving an anion exchange resin with mixed anions will be readily understood by those skilled in the art of ion exchange.

The chemistry of chlorination of chlorite to form chlorine dioxide follows:

2HClO₂+HOCl--->2ClO₂+HCl+H₂O (7).

This chemistry is well known and used frequently to make chlorine dioxide. However, an additional reaction occurs when ion exchange resins are used, and it follows:

RH+ROH-->H₂O (8).

This “water reaction” does not interfere with the reaction to form the chlorine dioxide, and the water produced is not considered to be a contaminant in the reaction. It is merely a side reaction that takes place when H⁺ on and OH⁻ ion are exchanged off of the resin.

The cation and anion exchange resins can each be placed either in the same or different columns or tubes or other containers or platforms that can be operated singularly or connectively attached to each other by tubing that will allow a liquid solution to flow from one column or container to the next, and each column or container also having at least an inlet and outlet tubing.

The separate columns contemplated in the present invention would then be placed in sequence such that the cation exchange resin is contacted by the precursor solution first, followed by the solution contacting the anion exchange resin mixture or mixtures. For example, a known concentration of a solution containing Na₂SO₄ is fed into the inlet tube connected to the first resin column having the cation exchange resin. The Na₂SO₄ solution would flow through into the cation exchange resin where the Na⁺ ions would exchange with the H⁺ ions on the cation resin to form H₂SO₄, and the cation resin will exhaust to the Na⁺ form. Further, any cationic contaminant, either from the precursor solution or formed as a byproduct of the reaction, is removed with the cation exchange resin.

The decationized solution will pass into and contact the second column having the anion exchange resin mixture, where the SO₄⁻ ions from the original Na₂SO₄ solution will exchange with the OCl⁻, ClO₂⁻, and OH⁻ ions on the anion exchange resin, forming the active halogen dioxide, chlorine dioxide, within the ion exchange material. Further, any anionic contaminant, either from the precursor solution or formed as a byproduct of the reaction, is removed with the anion exchange resin.

Additionally, the anion exchange resin of the above example can also be mixed or layered with an insoluble catalyst in order to enhance the formation of chlorine dioxide. Furthermore, it is also contemplated that the precursor solution of the above example may also contain a soluble catalyst, such as chloride ion (Cl⁻).

In another preferred embodiment of the present invention, a cation exchange resin is placed in the hydrogen form. The stable halogen oxide, sodium hypochlorite, and the stable halogen dioxide, sodium chlorite, are passed over the cation exchange resin such that the sodium ion of both precursor solutions exchanges with the hydrogen ion on the resin and then reacts to form the active halogen dioxide, chlorine dioxide. This reaction is described by equation (7) shown previously.

One skilled in the art of ion exchange would understand that different types of resins could be substituted in the above examples. For example, the cation resin used in the above examples can also be substituted for a weak acid cation resin, and the anion resin can be substituted for a weak base anion resin. Also, higher or lower cross-linked resins may be used as the application requires.

The potential sources for the NaCl solution in the previous examples can be varied, and include, for example, making the solution as needed, or from a brine tank of a water softening system. Water softeners employing ion exchange columns contain resin beads. The resin beads have a surface that attracts sodium, calcium and magnesium ions. The resin beads preferably bind calcium and magnesium ions. The beads are initially in the sodium ion state and the sodium ions will exchange off the resin with calcium and magnesium ions, thus softening the water that flows through the ions exchange column. The column may be cleaned of calcium and magnesium ions and the beads resupplied with sodium ions, by exposing the beads to a very high concentration of sodium ions, thus causing the exchange of the sodium ions in the brine with the hardness ions on the cation resin of the softener. The conventional source of sodium ions in these water softener systems is common salt i.e. sodium chloride. A brine tank containing salt crystals or pellets is partially flooded with water. The water dissolves the salt pellets and becomes saturated with salt. The saturated brine solution is then periodically run through the ion exchange column to regenerate the resin beads.

In the present invention, the reject effluent stream from a reverse osmosis system can be used as the source of acceptable counter ions. This source of counter ions would be especially useful if the active chlorine dioxide solution were being used to disinfect the reverse osmosis membranes to prevent, reduce, or eliminate biofouling. Reverse osmosis units have been used for a number of decades to purify water for home, municipal and industrial uses. Examples of purification systems using reverse osmosis units to provide quantities of potable water suitable for home or other relatively limited uses are shown in the following patents of Donald T. Bray: U.S. Pat. Nos. 3,568,843; 3,794,172; 3,794,173 and 3,939,074. Such self-contained systems were generally designed to provide potable water on demand by being essentially permanently connected to a municipal water supply line pressure. They created a ready reservoir of purified or potable water which would be available to be dispensed to a user, either by gravity flow or by flow driven by the expansion of air compressed behind a bladder within a confined tank or the like.

The particular configuration of the reverse osmosis system used does not matter. Basically, all reverse osmosis systems operate in a manner such that the unpurified water feed is introduced into the system at a pressure greater than the osmotic pressure of the unpurified water involved. This causes the water to permeate through a semi-permeable membrane by reverse osmosis. The purified water is removed from the system via a purified product outlet. As the water permeates through semi-permeable membrane, substantially all of the dissolved salts in such water are prevented from passing through the membrane, in accordance with known reverse osmosis principles. Such salts are maintained on the upstream side of the membrane. There is constantly removed from the upstream side of the membrane a reject effluent of the unpurified water, such reject effluent having the dissolved salt concentration thereof increased by the salts which are prevented from passing through the membrane. Such reject effluent is normally discharged either down the drain, or back to the source.

In addition, the ions in tap water may be used as a source of counter ions for the present invention.

The ion exchange materials of the present invention may be recharged or regenerated in a variety of ways known in the art. Complete regeneration of the ion exchange resins described herein is not necessary for the invention to work. In fact, it may be desirable in certain circumstances to leave the resin in a partially regenerated form to increase the stability of the precursor ion on the resin.

As used herein, the term “partially regenerated” shall refer to an ion exchange material wherein some of the ion exchange sites are intentionally placed in more than one form by conventional regeneration methods. To accomplish a partial regeneration, the ion exchange material should first be completely regenerated or placed in a state such that virtually all of the ion exchange sites are in a single form. Then a solution containing less than a stoichiometric quantity of a second ion is passed over the ion exchange material such that the solution partially regenerates the ion exchange material. This procedure can be repeated such that the ion exchange material is in multiple forms.

For example, it is contemplated in accordance with the present invention that one would leave an anion resin partially in the hydroxyl form to ensure a high pH and further stabilize a reactant such as hypochlorite ion or chlorite ion. It is also important to note that the ion exchange materials need not be regenerated at all. If the application warrants, the ion exchange materials can be placed in a disposable container and disposed of when they have no more useful life for the application.

The activated halogen dioxide, chlorine dioxide of the present invention can be used for many purposes. In a preferred embodiment of the present invention, the activated chlorine dioxide would be used to disinfect small volume applications. Such applications include, but are not limited to, ice machines, residential water softeners, residential water wells, hard surfaces, medical devices, and residential reverse osmosis systems. Use in larger commercial applications is also contemplated for the present invention; however, the economic advantages of the process become limited for such applications as they increase in scale. However, in a case such as large volume reverse osmosis systems, the amount of chlorine dioxide needed to disinfect the reverse osmosis membranes is small in comparison to the amount of water produced by the reverse osmosis system as demonstrated by Adams. Therefore, there are larger volume applications for which this process is applicable.

Small volume applications, as described previously, are good applications for the use of disposable ion exchange media. Such media would be placed in a container and used only until the media had exhausted, and the quality of the halogen dioxide, chlorine dioxide being produced by the media was inadequate for the application. At that time, the ion exchange media would be discarded. In applications such as residential water softeners, the ion exchange media may be discarded once per month. In other applications, such as the disinfection of medical devices, the ion exchange media may only be used for a few minutes and then discarded. If the application warranted, the entire container containing the ion exchange media would be discarded. However, if it were not viable to discard the container, it could be emptied of the exhausted ion exchange media and then refilled with ion exchange media in the stable reactant form.

It can be seen by the examples of these embodiments that the active halogen dioxide, chlorine dioxide can be formed by numerous configurations of precursor solutions and ion exchange media. Once the present invention is understood, it is within the scope of one skilled in the art to choose which configuration best suits a particular application.

### Examples of Apparatus for Carrying Out The Processes of the Present Invention

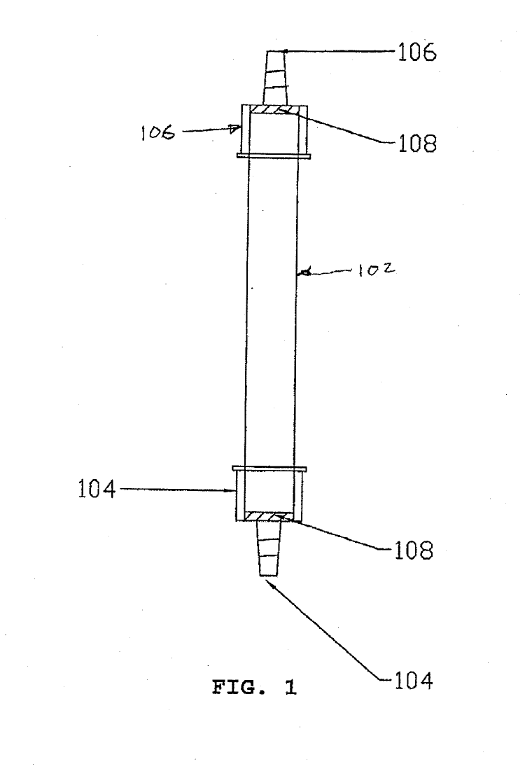

Containers in the form of plastic tubes used for carrying out the tests set forth in Examples 1-5 in the present application are shown in FIG. 1, and generally designated by reference numeral 100. The plastic test tube 100 includes a generally cylindrical body 102 having a conventional connection closure mounted at each end in the form of an inlet bottom connection 104 and an outlet upper end connection 106. Porex support media will be cut to fit the outer diameter of the cylindrical tube 102, and a Porex disk 108 will be placed at each end between the end of the cylindrical tubing 102 and the end closures 104 and 106 to act as support for the filling. The feed tubing will run to the inlet bottom connection 104 and outlet tubing will run from the outlet upper end connection 106.

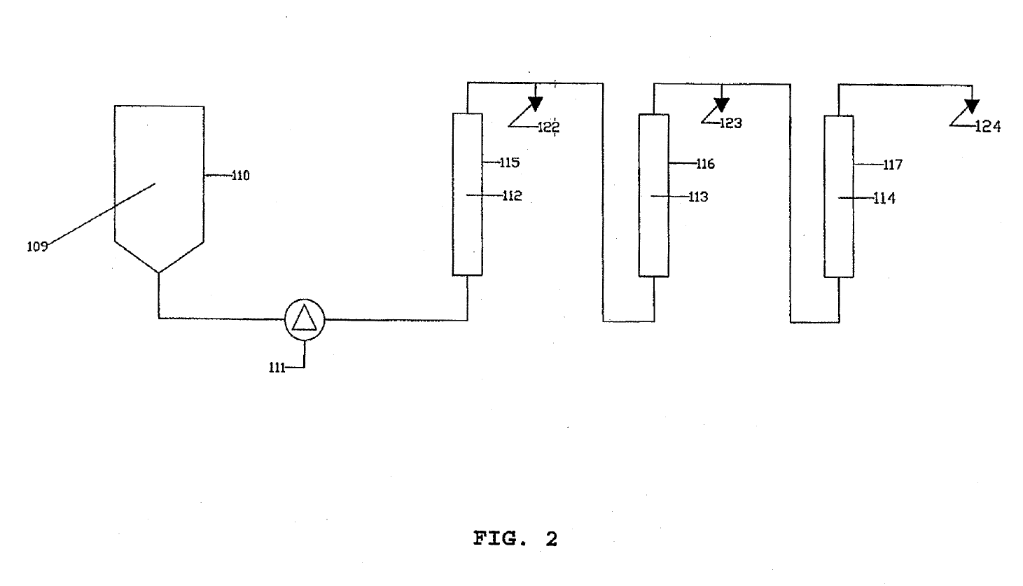

FIG. 2 depicts an example of the process wherein there exist three separate tubes containing ion exchange media (112, 113, 114), a precursor reservoir (110), precursor solution (109), a feed pump (111), and three separate sample ports (122, 123, 124). The feed pump (111) will deliver the precursor solution (109) from the precursor reservoir (110) to each of the tubes in series (112, 113, 114). Samples of the effluent from each tube can be obtained from each of the sample ports (122, 123, 124).

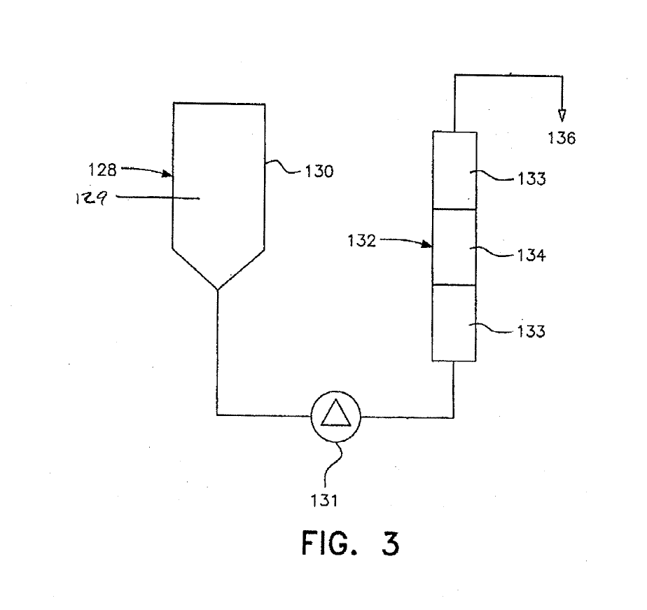

FIG. 3 depicts an example of the process wherein there exists one tube (132) containing three separate layers of ion exchange media (133,134, 135), a precursor reservoir (130), precursor solution (129), a feed pump (131), and a sample port (136). The feed pump (131) will deliver the precursor solution (129) from the precursor reservoir (130) to the tube (132). A sample of the effluent can be obtained from the sample port (136).

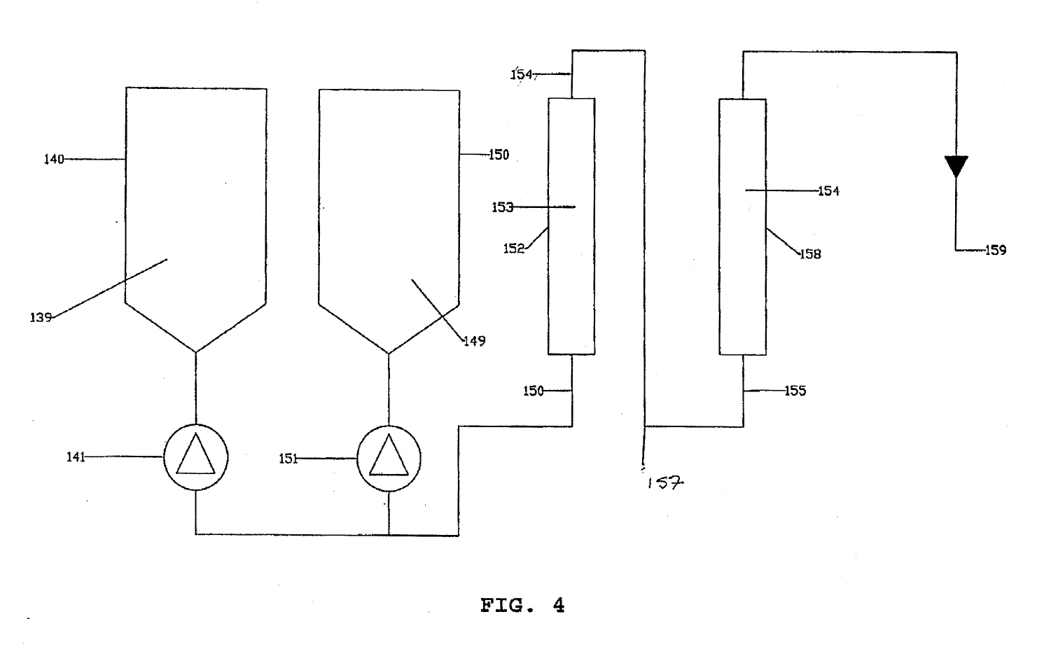

FIG. 4 depicts an example of the process wherein there exists two tubes (152, 158) each containing ion exchange media and/or catalyst material (153, 154), two precursor reservoirs (140,150), two precursor solutions (139, 149), two feed pumps (141, 151), and two sample ports (157, 159). The feed pumps (141, 151) will deliver the precursor solutions (139, 149) from the precursor reservoirs (140, 150) to the tubes (152, 158). Samples of the effluent can be obtained from the sample ports (157, 159).

### OPERATIONAL EXAMPLES

### Example 1

A first 30 ml plastic test tube 100 as shown in FIG. 1 was clipped to a wall with pipe clips in the configuration illustrated in FIG. 3 such that the bottom two ion exchange media layers 133 and 134 are utilized. The feed tubing was connected to a reservoir 130 containing a sodium sulfate (Na₂SO₄) solution 129 to the pump 131, and tubing was run from the pump 131 to the bottom inlet of the test tube 132. While the concentration of the Na₂SO₄ feed solution 129 is not critical, it is generally preferable to keep the concentration of counter ions in the precursor solution low enough such that the concentration of the resultant activated halogen dioxide, chlorine dioxide, is less than 10,000 ppm.

In example 1, the first ion exchange resin layer 133 was comprised of a commercially available strong cation exchange resin, Resintech CG-8 (ResinTech, Inc., West Berlin, N.J.), in the hydrogen form (H⁺). The second layer 134 was comprised of a strongly basic organic anion resin, ResinTech SBG1, in essentially complete chlorite form (ClO₂⁻) and mixed with a suitable insoluble catalyst such as platinum on zeolite. Such suitable catalysts may or may not be deposited onto the surface of a suitable substrate, such as zeolites or Macrolite® Media (Kinetico Inc. Newbury, Ohio). Examples of suitable insoluble catalysts can be platinum on zeolite, on Macrolite® media, or on carbon. However, other suitable catalysts are known to those schooled in the art. A continuous stream of 1000 mg/l of Na₂SO₄ solution was passed upwardly through the test tube 132. The resultant concentration of ClO₂ was 492 mg/l with a pH of 2.4.

Example 1 illustrates that ion exchange media can be effectively used to contribute reactants such that the activated halogen dioxide, chlorine dioxide, is formed from the exchange of the counter ions in the precursor solution. In this specific example, an insoluble catalyst is mixed with the ion exchange media so as to lower the activation energy of the formation of the active halogen dioxide, chlorine dioxide, and thus, increase the yield.

### Example 2

A first 30 ml plastic test tube 100 as shown in FIG. 1 was clipped to a wall with pipe clips in the configuration illustrated in FIG. 3 such that the bottom two ion exchange media layers 133 and 134 are utilized. The feed tubing was connected from a reservoir 130 containing a sodium chloride (NaCl) solution 129 to the pump 131, and tubing was run from the pump to the bottom inlet of the test tube 132. In this example, the chloride ion in the precursor solution acts as both a counter ion and a soluble catalyst. While the concentration of the NaCl feed solution is not critical, it is generally preferable to keep the concentration of counter ions in the precursor solution low enough such that the concentration of the resultant activated halogen dioxide, chlorine dioxide, is less than 10,000 ppm. The first ion exchange media layer 133 was comprised of a commercially available strong cation exchange resin, Resintech CG-8, in the hydrogen form (H⁺). The second layer 134 was comprised of a strongly basic organic anion resin, ResinTech SBG1, in essentially complete ClO₂⁻ chlorite form (ClO₂⁻ A continuous stream of NaCl solution (3000 mg/l) was passed upwardly through the test tube 135. The resultant concentration of ClO₂ was 1700 mg/l with a pH of 1.5.

Example 2 illustrates that ion exchange media can be effectively used to contribute reactants such that the activated halogen dioxide, chlorine dioxide, is formed from the exchange of the counter ions in the precursor solution. In this specific example, a soluble catalyst is used as counter ion in the precursor solution so as to lower the activation energy of the formation of the active halogen dioxide, chlorine dioxide, and thus, increase the yield.

### Example 3

A first 30 ml plastic test tube 100 as shown in FIG. 1 was clipped to a wall with pipe clips in the configuration shown in FIG. 2 such that tubes 115 and 116 are utilized. The feed tubing was connected from a reservoir 110 containing a sodium sulfate (Na₂SO₄) solution 109 to the pump 111, and tubing was run from the pump 111 to the bottom inlet of the first test tube 115. While the concentration of the Na₂SO₄ feed solution is not critical, it is generally preferable to keep the concentration of counter ions in the precursor solution low enough such that the concentration of the resultant activated halogen dioxide, chlorine dioxide, is less than 10,000 ppm. The product tubing from the first test tube 115 was also connected from the top outlet of the first tube 115 to the bottom inlet of a second 30 ml plastic test tube 116 also clipped to a wall with pipe clips.

In Example 3, the first test tube 115 was filled with a commercially available strong cation exchange resin 112, Resintech CG-8, in the hydrogen form (H⁺). The second test tube 116 was filled with a strongly basic organic anion resin 113, Resintech SBG1, and was partially in the ClO₂⁻ form and partially in the OCl⁻ form. The remaining anionic sites were in the hydroxyl (OH⁻) form to help ensure the stability of the chlorite and hypochlorite ions. A continuous stream of the Na₂SO₄ solution at a concentration of 1000 mg/l was passed upwardly through the first test tube 115 and into and through the second tube 116. A sample of solution was taken from the sample port 122 and had a pH of 1.7. The pH of the resultant solution from the outlet of the second tube taken at sample port 123 was 2.5, and the concentration of ClO₂ was 802 mg/l.

Example 3 illustrates that ion exchange media can be effectively used to contribute more than one reactant from a mixture of ion exchange material such that the activated halogen dioxide, chlorine dioxide, is formed from the exchange of the counter ions in the precursor solution. Hence, many variations of mixing, layering, or separating the ion exchange media in the stable reactant form can be used within the present invention.

### Example 4

A first 30 ml plastic test tube 100 as shown in FIG. 1 was clipped to a wall with pipe clips in the configuration shown in FIG. 2 such that tubes 115 and 116 are utilized. The feed tubing was connected from a reservoir 110 containing a sodium sulfate (Na₂SO₄) solution 109 to the pump 111, and tubing was run from the pump 111 to the bottom inlet of the first test tube 115. While the concentration of the Na₂SO₄ feed solution is not critical, it is generally preferable to keep the concentration of counter ions in the precursor solution low enough such that the concentration of the resultant activated halogen dioxide, chlorine dioxide, is less than 10,000 ppm. The product tubing from the first test tube 115 was then connected from the top outlet of the first tube 115 to the bottom inlet of a second 30 ml plastic test tube 116 also clipped to a wall with pipe clips.

The first tube 115 was filled with a commercially available weak cation exchange resin 112, Resintech WACMP in the hydrogen form (H⁺). The second tube 116 was filled with a weakly basic organic anion resin 113, Resintech WBMP, which was partially in the ClO₂⁻ form and partially in the OCl⁻ form. The remaining anionic sites were in the hydroxyl (OH⁻) form to help ensure stability of the chlorite and hypochlorite ions. A continuous stream of the Na₂SO₄ solution at a concentration of 1000 mg/l was passed upwardly through the first test tube 115 and into and through the second tube 116. The pH of the solution exiting the cation tube outlet was 3.7 as taken at sample port 122. The pH of the resultant solution was 4.1 as taken at sample port 123, and the concentration of ClO₂ was 720 mg/l.

Example 4 demonstrates that various types of ion exchange media, such as weak acid cation and weak base anion, can be used in the context of the present invention, and the selection of such ion exchange media is within the skill of one knowledgeable in the art.

### Example 5

A first 30 ml plastic test tube 100 as shown in FIG. 1 was clipped to a wall with pipe clips in the configuration shown in FIG. 4 such that tubes 152 and 158 are utilized. The feed tubing was connected from two reservoirs 140 and 150. Reservoir 140 contains a sodium chlorite (NaClO₂) solution 139 and reservoir 150 contains a sodium hypochlorite (NaOCl) solution 149. Tubing from reservoir 140 is connected to pump 141, and tubing is run from pump 141 to the bottom inlet of the first test tube 152. Tubing from reservoir 150 is connected to pump 151, and tubing is run from pump 151 to the bottom inlet of the second test tube 158. The precursor solutions 139 and 149 from each reservoir were mixed before entering the first test tube 152. While the concentration of the feed solutions is not critical, it is generally preferable to keep the concentration of counter ions in the precursor solutions low enough such that the concentration of the resultant activated halogen dioxide, chlorine dioxide, is less than 10,000 ppm. The product tubing from the first test tube 152 was connected from the top outlet of the first tube 152 to the bottom inlet of a second 30 ml plastic test tube 158 also clipped to a wall with pipe clips.

In Example 5, the first test tube 152 was filled with a commercially available strong cation exchange resin 153 sold under the name Resintech CG-8 and is in the hydrogen form (H⁺). The second test tube 158 was filled with an immobile catalyst of platinum on zeolite 154. Also in this example, the concentration of sodium hypochlorite 149 was varied to determine the effect of the oxidizer in the reaction to form chlorine dioxide, but the inlet concentration of ClO₂⁻ 139 was held constant at 902 mg/l. A continuous stream of the precursor solutions was passed upwardly through the first test tube 152 and into and through the second tube 158. Samples of solution were taken after both the first and the second tube's top outlet ends through sample ports 159 and 160 and analyzed for the activated halogen dioxide, chlorine dioxide. The results are shown in Table 1 below.

TABLE 1

| % Stoichiometric | Product Tube One | Product Tube Two |
|---|---|---|
| OCl⁻ | ClO₂ conc. (mg/l) | ClO₂ conc. (mg/l) |
| 11 | 105 | 540 |
| 22 | 205 | 560 |
| 33 | 285 | 560 |
| 44 | 375 | 562 |
| 55 | 450 | 562 |
| 66 | 562 | 562 |
| 77 | 610 | 616 |
| 88 | 710 | 600 |
| 99 | 760 | 550 |
| 110 | 800 | 536 |
| 115 | 810 | 516 |

Example 5 demonstrates that two or more precursor solutions, themselves containing stable reactants, can be used in the context of the present invention. Thus, multiple precursor solutions can also be utilized. Also shown in this example is how controllable the chemistry is within the present invention. As the sodium hypochlorite feed solution rate was varied, the concentration of the resultant chlorine dioxide approached theoretical conversion as shown in equation 7. It is also well known that when using the chemistry described in equation 7 chlorate formation is expected as the ratio of hypochlorous to chlorite ion increases, because chlorine dioxide is destroyed by the hypochlorous acid via the following reaction:

HOCl+2ClO₂+H₂O>2HClO₃⁻+HCl (9)

The formation of chlorate is further illustrated by the decrease in concentration of chlorine dioxide after the catalyst column when the stoichiometric percentage of OCl⁻ exceeds 66%. As the activation energy of the reaction is lowered, chlorine dioxide is decomposed to chlorate by the catalyst by a similar mechanism as it does when exposed to UV light.

Having described the invention, many modifications thereto will become apparent to those skilled in the art to which it pertains without deviation from the spirit of the invention as defined by the scope of the appended claims.

1. A process for producing the activated halogen dioxide, chlorine dioxide, from its chlorite reactant using ion exchange media in a stable reactant form comprising the steps of:
1) passing one or more stable precursor solutions containing a known concentration of counter ions through an ion exchange media in a moist environment;
2) exchanging said counter ions with the ions present on said ion exchange media, which said ion exchange media both contributes reactants to said moist environment and extracts contaminants from said moist environment via its ion exchange mechanism; and
3) producing the activated halogen dioxide, chlorine dioxide, within the ion exchange media.

2. The process of claim 1, wherein said ion exchange media is partially in the stable reactant form.

3. The process of claim 1, wherein said ion exchange media is mixed with an additive.

4. The process of claim 1, wherein said counter ions are derived from one or more stable precursor solutions that contain reactants, which do not act as the counter ions in the process.

5. The process of claim 1, wherein said one or more stable precursor solutions contain at least one soluble catalyst, which may act as the counter ions in the process.

6. The process of claim 1, wherein said ion exchange material is mixed or layered with one or more insoluble catalysts.

7. The process of claim 1, wherein said ion exchange material is a singular ion exchange material, a layered ion exchange material or a mixed ion exchange material.

8. The process of claim 1, wherein the source of said counter ions are selected from the group consisting of a brine solution, reject effluent from a reverse osmosis system, or tap water.

9. An apparatus for producing the activated halogen dioxide, chlorine dioxide, using the process of claim 1 comprising: at least one container, each having an inlet and an outlet; said containers being connected to each other in series, wherein said first container is connected and in communication with at least one precursor reservoir at its inlet, and said outlet of the first container also connected and in communication with the inlet of said second container;
the outlet of said second container connected and in communication with the inlet of the third container; and so on, each container also containing ion exchange media;
said precursor reservoir or reservoirs each containing a precursor solution;
corresponding feed pumps, having an inlet and outlet, disposed in between and in communication with the precursor reservoir or reservoirs and the inlet of said first container;
wherein said feed pump or pumps is capable of delivering the precursor solution or solutions from the precursor reservoir or reservoirs to the inlet of the first container; and
a sample port after each container, which is capable of allowing a sample of the effluent from either of the containers to be obtained.

10. An apparatus for producing the activated halogen dioxide, chlorine dioxide using the process of claim 1 comprising:
a container, having an inlet and an outlet;
said container containing ion exchange media, wherein said ion exchange media is composed of at least two layers of ion exchange media;
at least one precursor reservoir each containing a precursor solution;
corresponding feed pumps, having an inlet and outlet, disposed in between and in communication with the precursor reservoir or reservoirs and the inlet of said container;
wherein said feed pump is capable of delivering the precursor solution or solutions from the precursor reservoir or reservoirs to the inlet of the first container; and
a sample port, capable of allowing a sample of the effluent from the container to be obtained.

11. An apparatus for producing the activated halogen dioxide, chlorine dioxide comprising:
a container, having an inlet and an outlet;
said container containing ion exchange media, wherein said ion exchange media is composed of at least one layer of ion exchange media;
at least one precursor reservoir each containing a precursor solution;
corresponding feed pumps, having an inlet and outlet, disposed in between and in communication with the precursor reservoir or reservoirs and the inlet of said container;
wherein said feed pump is capable of delivering the precursor solution or solutions from the precursor reservoir or reservoirs to the inlet of the first container; and
a sample port, capable of allowing a sample of the effluent from the container to be obtained;
wherein one or more stable precursor solutions containing a known concentration of counter ions is passed through at least one ion exchange media in a moist environment;
said counter ions are exchanged with the ions present on said ion exchange media, in which said ion exchange media both contributes reactants to said moist environment and extracts contaminants from said moist environment via its ion exchange mechanism; and
producing the activated halogen dioxide, chlorine dioxide.
